(19) United States
(12) Patent Application Publication
(10) Pub. No.: US 2006/0130607 A1
(43) Pub. Date: Jun. 22, 2006

(54) Cycle pedal

(76) Inventor: Michel Garnier, Junglinster (LU)

Correspondence Address: YOUNG & THOMPSON, 745 SOUTH 23RD STREET, 2ND FLOOR, ARLINGTON, VA, 22202, US

(21) Appl. No.: 10/534,092

(22) PCT Filed: Nov. 6, 2003
(86) PCT No.: PCT/FR03/03326

§ 371 Date: Jan. 13, 2006

(30) Foreign Application Priority Data
Nov. 6, 2002 (FR) 02/13968

(51) Int. Cl. G05G 1/14

(52) U.S. Cl. 74/594.6

(57) ABSTRACT

A pedal includes a plate (2) fitted with elements for locking (5, 6) a cyclist's shoe (8) remarkable in that the plate (2) extends beneath the pedal pin (4), the support axis (7) of the shoe on the plate (2) extending in front of the pedal pin (4) and in that the elements for locking (5, 6) include, a front interlocking mechanism (5) co-operating with the front part of a clip (9) integral with the sole (10) of the cyclist's shoe (8), and, a movable rear interlocking mechanism (6) co-operating with its rear part and moving under the pressure of the rear part of the clip (9) from an interlocked position, and passing through an open position allowing to insert the rear part of the clip (9), until returning to the interlocking position via elastic elements (20).

The invention relates to a cycle pedal intended for both road bicycles and mountain bicycles allowing to improve pedalling efficiency.

In the field of cycling, we are well aware of pedals comprising a globally rectangular pedal body fitted freely in rotation about an axis known as a pedal axis designed to be attached to the free end of a crank, said pedal body being fitted on one of its sides with a toe clip and a foot strap. Thus, the cyclist places the tip of his shoe onto the pedal body in the toe clip to transfer the force from the foot to the pedal body through both the pressure of the foot on the pedal body and through the upward traction when the cyclist's foot rises, so as to create a continuous pedal movement. This is the case, for example, in the French patent FR 2.432.970 which describes a bicycle toe clip comprising, on one hand, a body made of an elongated plate that is curved to the front in its median section to provide a curved part, a first and second end part respectively extending backwards from the two ends of the curved part of the plate and, on the other hand, a buckle located on the free end of the first end part and intended to hold a toe clip strap.

Furthermore, we are well aware of pedals known as automatic pedals comprising a grip element integral with the sole of a cyclist's shoe and designed to co-operate with the interlocking element located on the upper surface of a pedal constituted, in the same manner as the above, of a globally rectangular pedal body fitted freely in rotation about an axis known as a pedal axis designed to be attached to the free end of a crank.

These automatic bicycle pedals normally comprise a front interlocking element constituted of clamp creating a stop to interlock the front male end of a clip integral with the sole of a cyclist's shoe, and an interlocking rear male element created by an articulated clamp to interlock the rear male end of the clip on the cyclist's shoe. The rear clip is swivel mounted about a transversal pin and it is pre-stressed via an elastic means in the direction of an interlocking position whilst remaining movable under the pressure of the clip on the cyclist's shoe between an open position allowing to insert the front rear male end of the clip between the articulated clamp and a closed interlocking position in which the clip on the shoe is integral with the pedal. The elastic means consists of a coil spring and the articulated rear clamp can be displaced under pressure, in opposition to the pressure of the spring, in the direction of its open position to release the grip plate from its capture between the clamps. The articulated rear clamp is able to swivel by means of the rear male end of the clip on the cyclist's shoe which co-operates with the vertical walls of the articulated rear clamp creating cams which, during the rotation of the shoe towards the inside or the outside for uniting or respectively disuniting of the shoe from the pedal, pushes the clip backwards.

All these devices, despite allowing a satisfactory uniting of the cyclist's shoe to the pedal, does not allow to efficiently transfer the energy produced by the cyclist to the wheels.

One of the purposes of the invention is to overcome this inconvenience by proposing a bicycle pedal of straightforward design and cost effective allowing to improve the pedalling action of the cyclist.

For this reason, and according to the invention, a bicycle pedal is proposed comprising a pedal body constituted of a globally rectangular horizontal plate fitted on its upper surface with means for locking a cyclist's shoe and on one of its longitudinal edges a case containing a pedal pin designed to be fixed to the free end of a crank, said pedal is remarkable in that the plate is secured to the case so that its upper surface extends beneath the pedal pin along a distance a and the support axis of the shoe on the pedal plate which merges with the front plate passing through the metatarsus of the cyclist's big toe when the latter is pedalling, extends in front of the pedal pin along a distance b so that the pedal support axis describes a circular curve with centre O′ and radius r′ offset from a downwards and from b forward relative to the circular curve of the pedal pin with centre O, where O′ is the axis of the cycle bottom bracket shell and of radius r.

On the contrary, we are well aware of pedals of the prior art where the support axis of the shoe on the pedal plate merges with the pedal pin, said support axis extends beneath the pedal pin along a distance a and in front of the pedal pin along a distance b thus allowing to increase the pedal lever arm when the crank is driving and to decrease said lever arm when the crank is driven.

Other advantages and features will become clearer from the following description, given by way of non-restrictive example, of the bicycle pedal according to the invention and in reference to the attached drawings in which:

FIG. 1 is a perspective view of the bicycle pedal according to the invention,

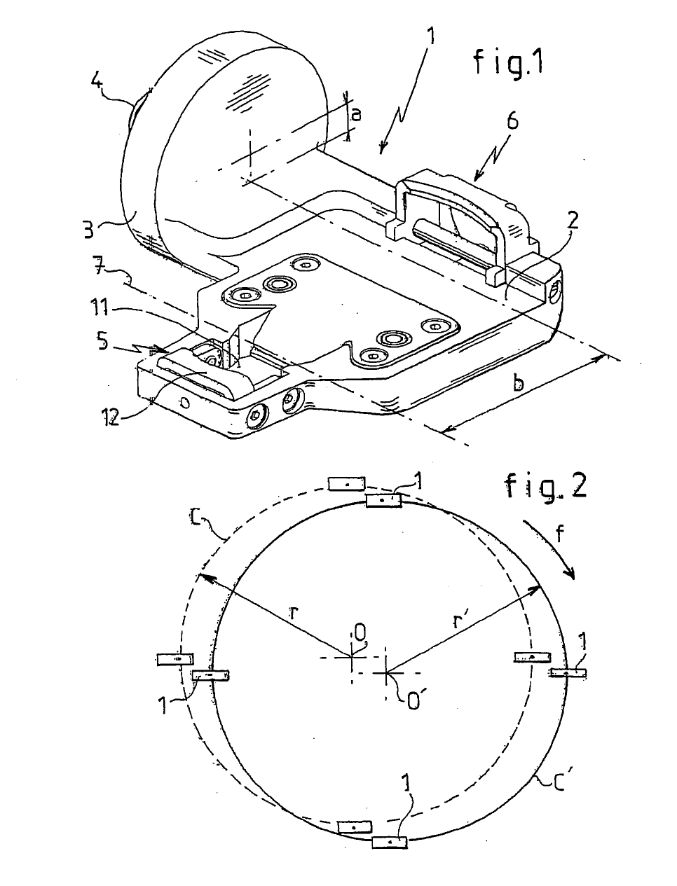

FIG. 2 is a diagrammatic representation of the travel of the pedal according to the invention during the revolution of the crank,

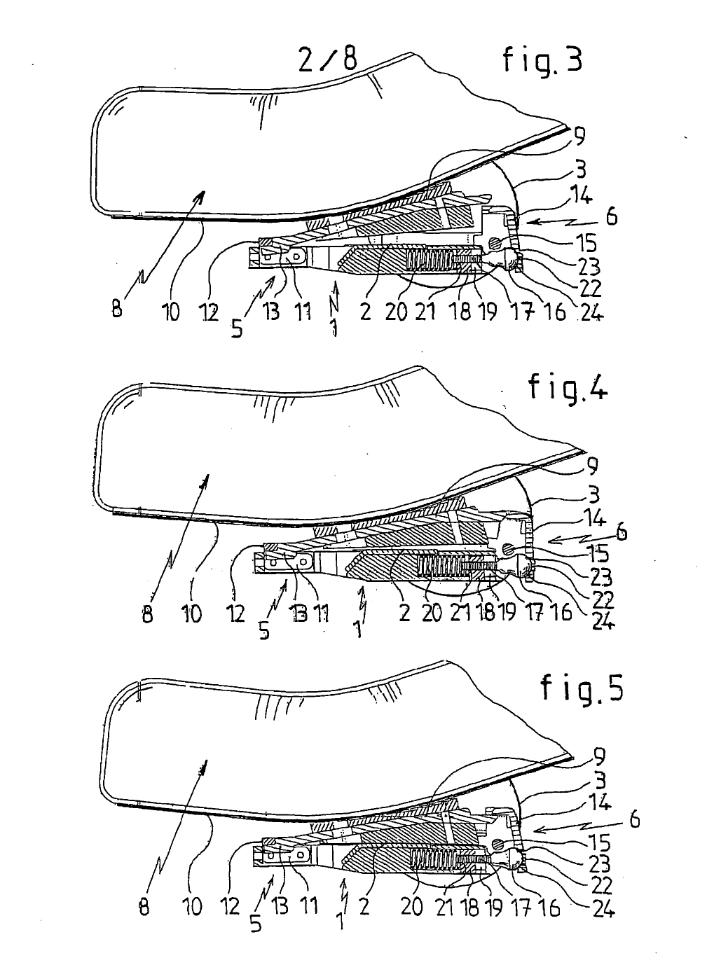

FIG. 3 is a longitudinal cross section of the bicycle pedal according to the invention represented in FIG. 1, with the front part of the clip on a cyclist's shoe being inserted into the front clamp of the pedal,

FIG. 4 is a longitudinal cross section of the bicycle pedal according to the invention represented in FIG. 1, with the rear part of the clip on a cyclist's shoe being inserted into the articulated rear clamp of the pedal,

FIG. 5 is a longitudinal cross section of the bicycle pedal according to the invention represented in FIG. 1, with the clip on the cyclist's shoe being locked into the front and rear clamps of the pedal,

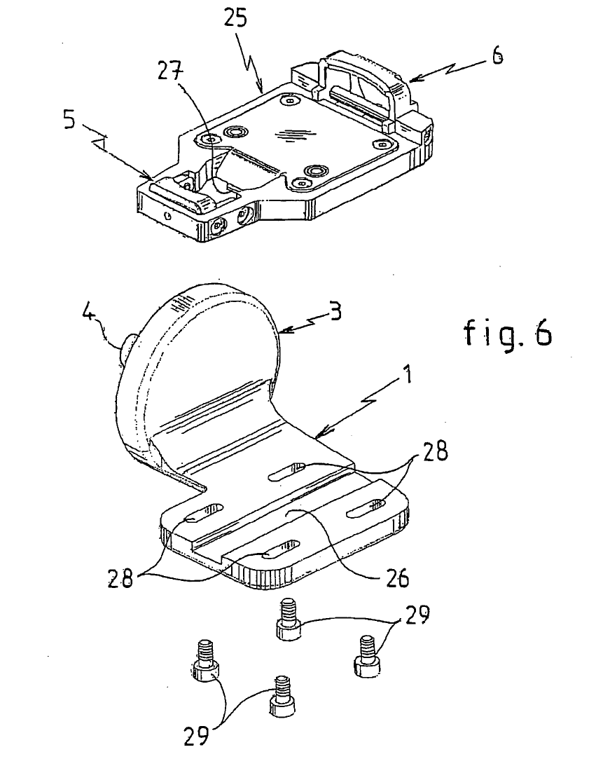

FIG. 6 is a perspective view of a first alternative embodiment of the bicycle pedal according to the invention,

FIG. 7 is a side view of a second alternative embodiment of the bicycle pedal according to the invention fitted with a toe clip,

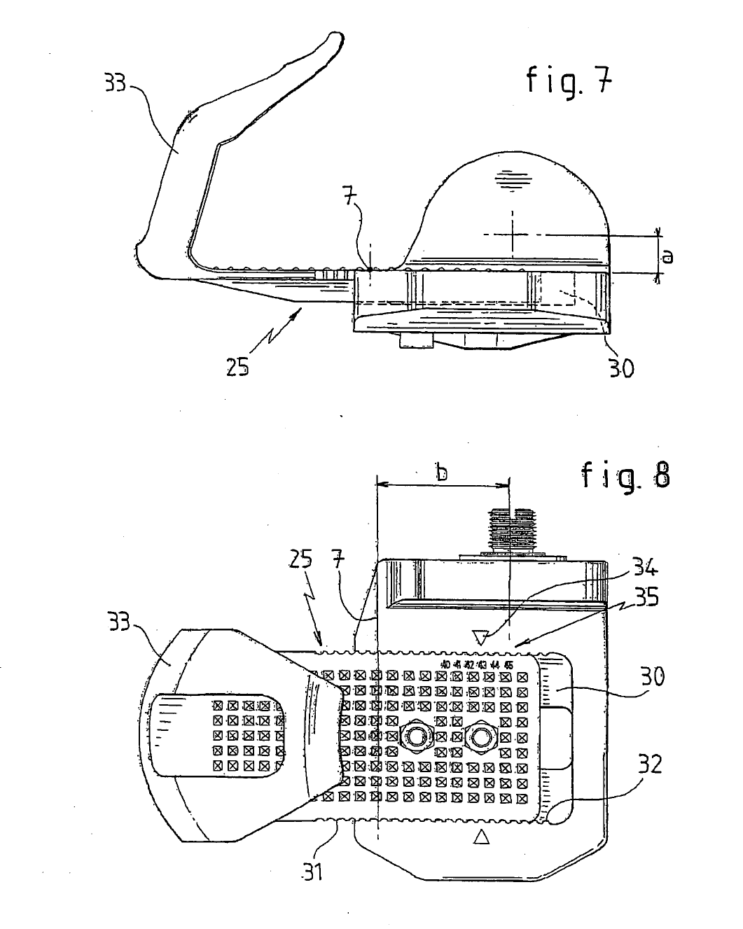

FIG. 8 is a top view of the alternative embodiment of the bicycle pedal according to the invention represented in FIG. 7,

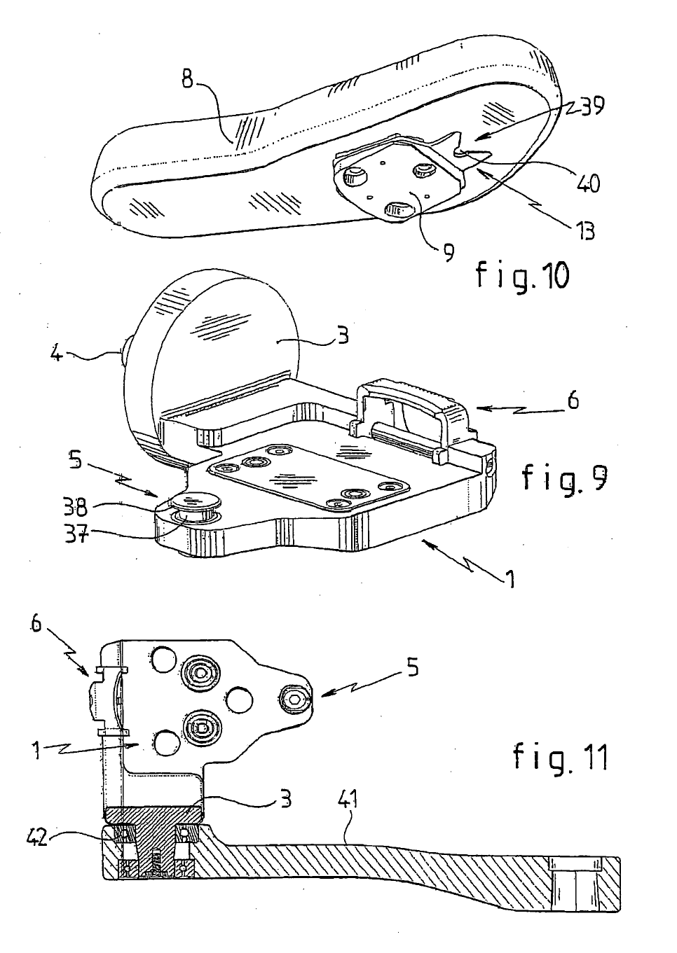

FIG. 9 is a perspective view of a third alternative embodiment of the bicycle pedal according to the invention,

FIG. 10 is a perspective view of the clip on the cyclist's shoe designed to co-operate with the front clamp of the alternative embodiment of the bicycle pedal according to the invention represented in FIG. 9,

FIG. 11 is a longitudinal cross section view of a crank equipped with another alternative embodiment of the bicycle pedal according to the invention,

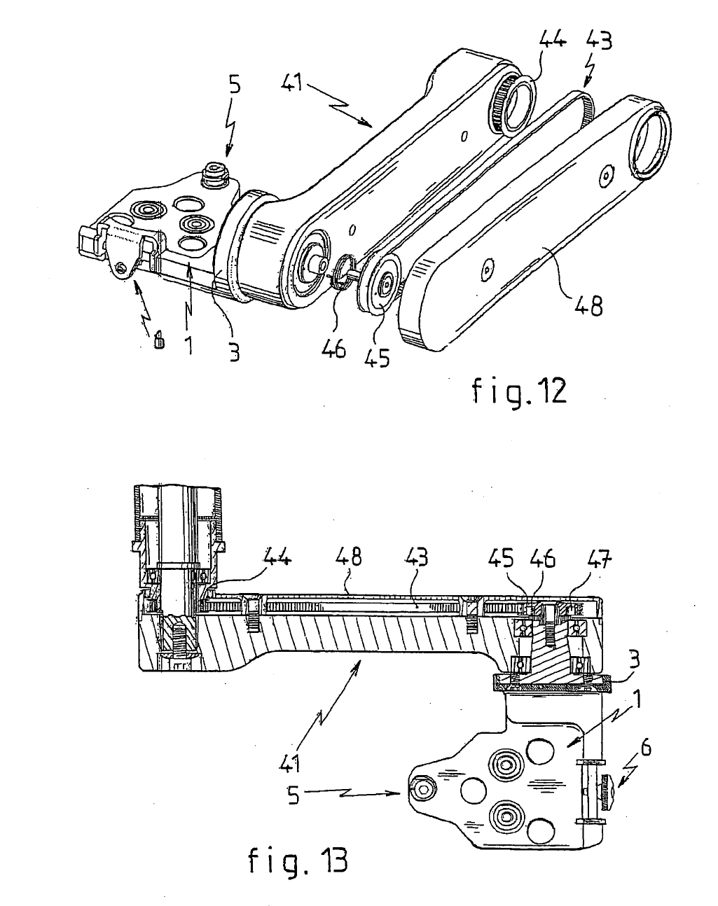

FIG. 12 is a perspective view of an alternative embodiment of the pedal according to the invention and of the crank,

FIG. 13 is a longitudinal cross section view of the crank equipped with the pedal according to the invention represented in FIG. 12,

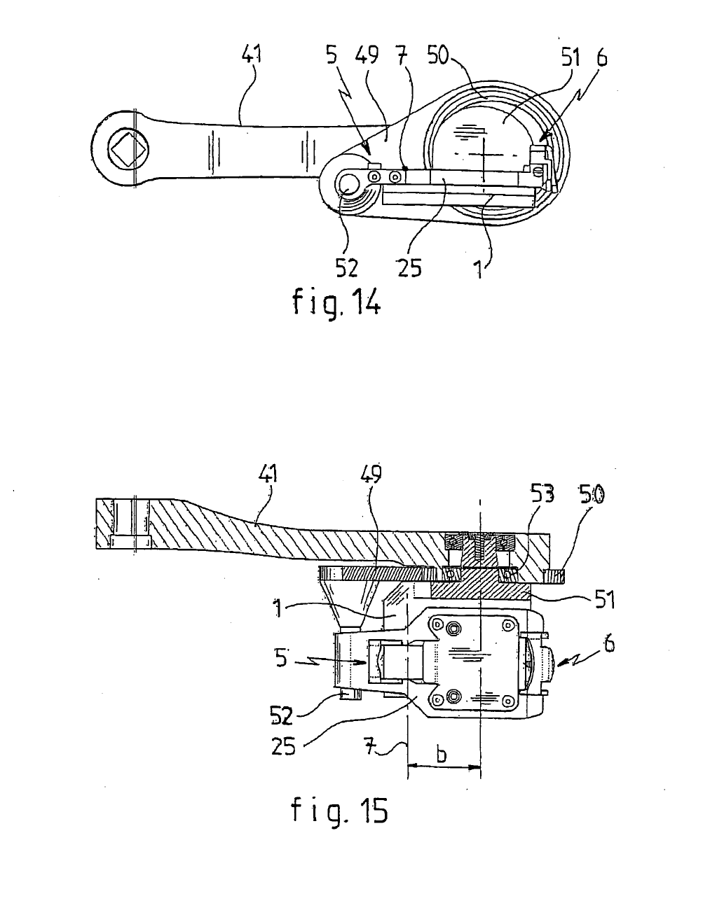

FIG. 14 is a side view of a last alternative embodiment of the bicycle pedal according to the invention,

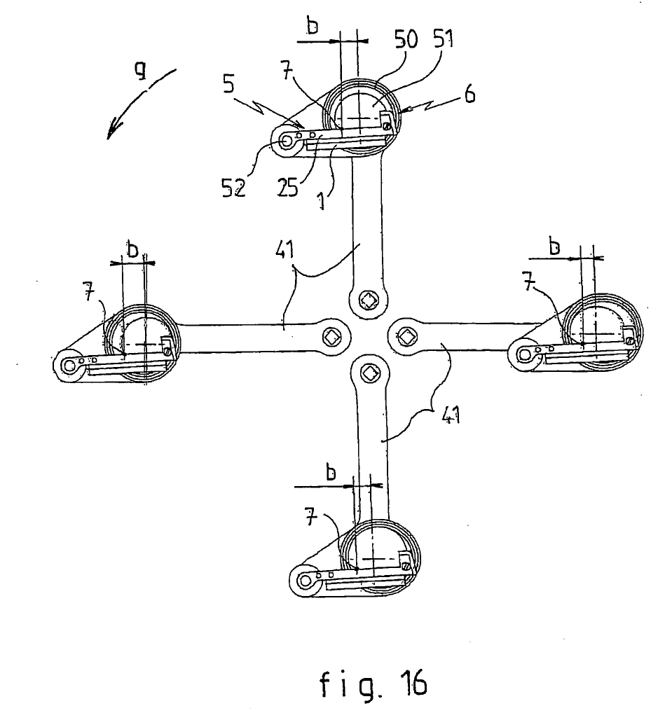

FIG. 15 is a longitudinal cross section of the alternative embodiment of the pedal represented in FIG. 14,

FIG. 16 is a diagrammatic representation of the travel of the alternative embodiment of the pedal according to the invention represented in FIGS. 14 and 15 during a revolution of the crank.

In reference to FIG. 1, the bicycle pedal according to the invention comprises a pedal body 1 constituted of a globally rectangular horizontal plate 2 fitted on one of its longitudinal edges a case 3 containing a pedal pin 4 designed to be fixed to the free end of a crank, not represented in the figure, and on its upper surface with front 5 and rear 6 means for locking a cyclist's shoe.

It goes without saying that the pedal pin 4 is fitted onto a ball bearing located in the case 3 of the pedal body 1 in order to allow the rotation of the horizontal plate 2 about the pedal pin 4 during pedalling.

The plate 2 is secured to the case 3 so that its upper surface extends beneath the pedal pin 4 along a distance a and that the support axis 7, represented by a dot and dash line in FIG. 1, of the shoe on the pedal plate 2, which merges with the front plane passing through the metatarsus of the cyclist's big toe when the latter is pedalling, extends in front of the pedal pin 4 along a distance b. Thus, the support axis 7 describes, in reference to FIG. 2, when pedalling clockwise as indicated by arrow f, a circular curve C′ with centre O′ and radius r′ offset from a downwards and from b forward relative to the circular curve of the pedal pin with centre O, where O′ is the axis of the cycle bottom bracket shell and of radius r.

We note that the curve C corresponds to the travel of a pedal of the prior art, that being a pedal whose upper surface of the plate, and the support axis 7 of the shoe on said pedal plate 1 merge with the pedal pin 4 attached to the far free end of the crank. Furthermore, we note that in the vicinity of the top dead centre, that being in the vicinity of the upper end of the curve C′, the support-axis 7 of the shoe on the pedal plate 1 is forward in relation to the support axis of the shoe of a pedal of the prior art, which produces a faster passage of the top dead centre. Moreover, in the anterior upper quadrant and on the largest part of the anterior lower quadrant of the curve C′, the support axis 7 of the shoe on the pedal plate 1 is located in front of the position of the support axis of the shoe on the plate of a pedal of the prior art thus creating a lever arm bigger than the pedals of the prior art which facilitates the pedalling action, of the cyclist by producing greater stress for a same applied force on the pedal. Finally, between the bottom dead centre, that being the passage point of the support axis of the shoe on the pedal plate 1 at the lower end of the curve C′, and as far as the top dead centre, the support axis 7 of the shoe on the pedal plate 1 is also located forward of the support axis of the pedal of the prior art which does not alter the pedal efficiency according to the invention as between the bottom dead centre and the top dead centre the cyclist applies practically no pressure on the pedal.

In reference to FIGS. 1, 3, 4 and 5, the bicycle pedal according to the invention comprises on the upper surface of the plate 1 front 5 and rear 6 means for locking a cyclist's shoe 8 (FIGS. 3 to 5). The means for locking 5 and 6 of a shoe 8 comprise, on one hand, a front interlocking mechanism 5 designed to co-operate with the front part of a clip 9 integral with the sole 10 of the cyclist's shoe 8 and, on the other hand, a movable rear interlocking mechanism 6 designed to co-operate with the rear part of the clip 9 of the shoe 8, the movable rear interlocking mechanism 6 being movable under the pressure of the rear part of the clip 9 of the shoe 8 from a position called interlocked, and passing through an open position allowing to insert or remove the rear part of the clip 9 of the shoe 8, until returning to the interlocking position under stress from an elastic means which will be described later on.

The front interlocking mechanism 5 consist in a recess 11 made in the upper surface of the plate 1, in its front part, and in which a clamp 12 is located which slightly juts out from the upper surface of the plate 1 which is designed to receive means for fitting a lug 13 jutting out from the front part of the clip 9 of the cyclist's shoe 8. This clamp 12 consist, for example, in a U-shaped metal part whose legs are attached to the inner walls of the recess 11 made in the upper surface of the plate 1 so that the base of the U extends globally parallel to the upper surface of the plate 1 by slightly jutting out from the latter.

Furthermore, the movable rear interlocking element 6 consists in a second clamp 14 articulated about a transversal pin 15 extending from the rear of the plate 1, said transversal pin 15 extending parallel to the axis 4 of the pedal case 3, and from the lower end of which leans a spherical mounting 16 located at the free end of a rod 17 extending longitudinally beneath the transversal hinge pin 15 of the clamp 14. This rod 17 is integral with a piston 18 sliding within a longitudinal recess 19 made in the plate 1 and opening out onto the rear end of said plate 1, said piston 18 leaning against a coil spring 20 located in said longitudinal recess 19. The rod 17 preferably consists of a threaded rod co-operating with a thread 21 made in the piston 18 sliding along the longitudinal recess 19. Moreover, the free end of the swivel mounting 16 comprises a screw head 22 extending across an opening 23 made in the lower end of the clamp 14 and opening out onto its rear surface, the swivel mounting 16 leaning against a concave hollow 24 whose radius of curvature is identical to that of the swivel mounting 16.

The fastening of a shoe to a bicycle pedal according to the invention in reference to FIGS. 3 to 5 will now be described.

The lug 13 jutting out from the front part of the clip 9 of the shoe 8 is inserted into the recess 11 until said lug 13 is embedded beneath the front clamp 12 (FIG. 3). The cyclists then presses down on his heel until the rear part of the clip 9 of the shoe 8, advantageously bevelled, leans against the second clamp 14 of the rear interlocking mechanism 6 rotating the latter about its axis 15. We note that when the second clamp 14 is rotating, the swivel mounting 16 drives the rod 17 and the piston 18 in a straight line into the longitudinal recess 19 by compressing the coil spring 20 (FIG. 4). By continuing to press his heel down, the clip 9 then leans against the upper surface of the pedal plate 1, the rear end of the clip 9 then extending beneath the clamp 14 of the rear interlocking mechanism 6 which has returned to its initial position known as interlocking under pressure from the coil spring 20 which moved the piston 18 and the rod 17 at the free end of which the swivel mounting 16 is merged in order to rotate the second clamp 14 until it reaches its initial interlocking position. Traditionally, the retracting of the clip 9 between the front interlocking mechanism 5 and the rear interlocking mechanism 6 is performed by supinating the ankle allowing to release the rear part of the clip 9 from the rear interlocking mechanism 6.

According to a first alternative embodiment of the bicycle pedal according to the invention, in reference to FIG. 6, said plate 1 comprises a movable plate 25 on its upper surface designed to slide longitudinally and on the upper surface of which merge the front 5 and rear 6 means for locking a cyclist's shoe, such as described above, in order to adapt the longitudinal position of said front 5 and rear 6 means for locking of the shoe according to the shoe size of the cyclist or even to adjust the distance b separating the pedal pin 4 from the support axis 7 of the shoe on the pedal plate 1. The upper surface of the plate 1 comprises a U-shaped longitudinal groove 26 of transversal section in which a U-shaped longitudinal guide 27 of transversal section slides beneath the movable plate 25 comprising the front 5 and rear 6 locking mechanisms. The plate 1 further comprises four longitudinal oblong openings 28 located on either side of the longitudinal groove 26 and crossed by bolts 29 designed to co-operate with the corresponding threaded holes made in the lower surface of the movable plate 25.

Of course the plate 1 can comprise but two longitudinal oblong openings 28 whilst remaining within the scope of the invention.

According to a second alternative embodiment of the bicycle pedal according to the invention, in reference to FIGS. 7 and 8, the plate 1 comprises, as does the above, a movable plate 25 on its upper surface designed to slide longitudinally and on the upper surface of which merge the means for locking a cyclist's shoe. The upper surface of the plate comprises a longitudinal hollow 30 opening out onto its front end and in which the movable plate 25 slides so that the upper surface of said plate 25 is flush with the upper surface of the plate 1. The longitudinal edges of the movable plate 25 comprise the toothed elements 31 designed to co-operate with the complementary toothed elements 32 integral with the longitudinal edges of the hollow 30 of the plate 1 in order to ensure the locking of the plate 25 in said hollow 30. The means for locking the cyclist's shoe are constituted in a toe clip 33 integral with the front end of the movable plate 25. Furthermore, in order to attain the longitudinal position of the means for locking the shoe, that being of the movable plate 25, according to the shoe size of the cyclist, the upper surface of the plate 1 advantageously comprises an indicator 34 designed to coincide with the digital references 35, indicating the shoe size of the cyclist, located on the upper surface of the movable pedal plate 25.

According to another alternative embodiment of the pedal according to the invention, in reference to FIGS. 9 and 10, the front interlocking mechanism 5 of the pedal can consists in a stud 37 extending vertically from the upper surface of the plate 1, in its front part, and comprising retention means at its upper end created by a flange 38, said stud 37 lodging into a recess 39 made in a lug 13 which juts out from the front part of the clip 9 of the cyclist's shoe 8 and which is V shaped at the bottom of which a globally semicircular complementary recess 40 is made whose diameter is slightly bigger than the diameter of the stud 37.

Of course the retention means located at the upper end of the stud 37 can consist in radial ribs whilst remaining within the scope of the invention.

Furthermore, it is obvious that the case 3 of the pedal body can merge with the free end of a crank 41 on a ball bearing 42 integral with the free end of said crank 41, such as represented in FIG. 11, the case 3 no longer containing any pedal pins 4 fitted onto a ball bearing integral with said case 3.

According to another embodiment of the pedal according to the invention, in reference to FIGS. 12 and 13, the pedal/crank unit 41 comprises a belt 43 extending along the crank 41 between a drive pinion 44 integral with the cycle bottom bracket shell and a driven pinion 45 integral with the case 3 of the pedal so that the rotational movement of the crank 41 rotates the pedal plate 1 at pedal pin height. The driven pinion 45 is integral with the case 3 of the pedal by means of a coil spring 46 located on the inside of a circular recess 47 made in the driven pinion 45 so that the axis of the spring extends in a coaxial manner to the axis of rotation of the driven pinion 45, the ends of the coil spring 46 being respectively integral with the driven pinion 45 and the case 3 of the pedal.

Of course the driven pinion 45 can be integral with the case 3 of the pedal through any elastic means known to those skilled in the art.

Preferably, a safety gear case 48 is designed to be fitted onto the crank 41 to cover the belt 43 and the drive 44 and driven 45 pinions.

Finally, according to a last alternative embodiment of the pedal according to the invention, in reference to FIGS. 14 to 16, the latter comprises a movable plate 25 designed to slide longitudinally along the upper surface of the pedal plate 1, the movable plate 25 being fitted with front 5 and rear 6 means for locking a cyclist's shoe. The pedal further comprises a connecting rod 49 of which a first end is freely mounted in rotation about an eccentric 50 of a case 51 integral with the free end of the crank 41 and whose second end comprises a transversal pin 52 about which the front end of the movable pedal plate 25 is freely mounted in rotation, the rear part of the pedal plate 1 being freely mounted in rotation about the axis of the free end of the crank 41 on a ball bearing 53.

Such a configuration allows to vary the distance b separating the pedal pin from the support axis 7 of the shoe on said pedal throughout the entire circular revolution of the pedal during the action of pedalling. Thus, in reference to FIG. 16, during an anticlockwise revolution of the pedal, as indicated by the arrow g, the pedal plate 1 remains globally horizontal during the revolution of the pedal and the distance b separating the pedal pin from the support axis 7 of the shoe on said pedal increases in the anterior and posterior upper quadrants, that being between the positions where the crank 41 is located globally horizontally forwards and backwards, then decreases in the anterior and posterior lower quadrants. We note that the distance b separating the pedal pin from the support axis 7 of the shoe on said pedal is maximal when the pedal is located in its globally horizontal forward position, that being when the pressure applied by the cyclist's foot is also maximal thus providing greater torque during pedalling in relation to pedals of the prior art.

Finally, it goes without saying that the examples that we have presented are only specific illustrations and in no way restrict the scope of the invention.

1-21. (canceled)

22. Cycle pedal comprising a pedal body (1) constituted of a globally rectangular horizontal plate (2) fitted on its upper surface with means for locking (5, 6) a cyclist's shoe (8) and on one of its longitudinal edges a case (3) containing a pedal pin (4) designed to be fixed to the free end of a crank (41) characterised in that the plate (2) is secured to the case (3) so that its upper surface extends beneath the pedal pin (4) along a distance a and the support axis (7) of the shoe on the pedal plate (2) which merges with the front plate passing through the metatarsus of the cyclist's big toe when the latter is pedalling, extends in front of the pedal pin (4) along a distance b so that the pedal support axis (7) describes a circular curve with centre O′ and radius r′ offset from a downwards and from b forward relative to the circular curve of the pedal pin (4) with centre O, where O′ is the axis of the cycle bottom bracket shell and of radius r and in that the means for locking (5, 6) comprise, on one hand, a front interlocking mechanism (5) designed to co-operate with the front part of a clip 9) integral with the sole (10) of the cyclist's shoe (8) and, on the other hand, a movable rear interlocking mechanism (6) designed to co-operate with the rear part of the clip (9) of the shoe (8), the movable rear interlocking mechanism (6) being movable under the pressure of the rear part of the clip (9) of the shoe (8) from a position called interlocked, and passing through an open position allowing to insert or remove the rear part of the clip (9) of the shoe (8), until returning to the interlocking position under stress from an elastic means (20).

23. Pedal set forth in claim 22, characterised in that the plate (2) movable plate (25) on its upper surface designed to slide longitudinally and on the upper surface of which merge the means for locking (5, 6) a cyclist's shoe (8) in order to adapt the longitudinal position of said means for locking (5, 6) of the shoe (8) according to the shoe size of the cyclist or even to adjust the distance b separating the pedal pin (4) from the support axis (7).

24. Pedal set forth in claim 23, characterised in that the plate (2) comprises at least two longitudinal openings (28) crossed by two bolts (29) designed to co-operate with two threaded holes made in the lower surface of the movable plate (25).

25. Pedal set forth in claim 22, characterised in that the front interlocking mechanism (5) consist in a recess (11) made in the upper surface of the plate (2), in its front part, and in which a clamp (12) is located which slightly juts out from the upper surface of the plate (2) and in which a lug (13) fits jutting out from the front part of the clip (9) of the cyclist's shoe (8).

26. Pedal set forth in claim 22, characterised in that the front interlocking mechanism (5) consists in a stud (37) extending vertically from the upper surface of the plate (2), in its front part, and comprising retention means (38) at its upper end, said stud (37) lodging into a recess (39) made in a lug (13) which juts out from the front part of the clip (9) of the cyclist's shoe (8) and which is V shaped at the bottom of which a globally semicircular complementary recess (40) is made whose diameter is slightly bigger than the diameter of the stud (37).

27. Pedal set forth in claim 26, characterised in that the retention means (38) consist in a flange.

28. Pedal set forth in claim 26, characterised in that the retention means (38) consist in radial ribs.

29. Pedal set forth in claim 22, characterised in that the movable rear interlocking element (6) consists in a clamp (14) articulated about a transversal pin (15) extending from the rear of the plate (2) and on the lower end of which leans a spherical mounting (16) located at the free end of a rod (17) extending longitudinally beneath the transversal hinge pin (15) of the clamp (14) and integral with a piston sliding within a longitudinal recess (19) made in the plate (2) and opening out onto the rear end of said plate (2), said piston (18) leaning against a coil spring (20) located in said longitudinal recess (19).

30. Pedal set forth in claim 29, characterised in that the rod (17) consists of a threaded rod co-operating with a threaded hole (21) made in the piston (18) sliding along the longitudinal recess (19).

31. Pedal set forth in claim 30, characterised in that the free end of the swivel mounting (16) comprises a screw head (22) extending across an opening (23) made in the lower end of the clamp (14) and opening out onto its rear surface.

32. Pedal set forth in claim 30, characterised in that the swivel mounting (16) leans against a concave hollow (24) whose radius of curvature is identical to that of the swivel mounting (16).

33. Pedal set forth in claim 23, characterised in that it comprises means for varying the distance b separating the pedal pin (4) from the support axis (7) of the shoe (8) on said pedal throughout the entire revolution of the pedal during the action of pedalling.

34. Pedal set forth in claim 33, characterised in that it comprises a connecting rod (49) of which a first end is freely mounted in rotation about an eccentric (50) of a case (51) integral with the free end of the crank (41) and whose second end comprises a transversal pin (52) about which the front end of the movable pedal plate (25) is freely mounted in rotation which is designed to slide longitudinally along the upper surface of the plate (2), the rear part of said pedal plate (2) being freely mounted in rotation about the axis of the end of the crank (41).

35. Pedal set forth in claim 22, characterised in that it comprises a belt (43) extending along the crank between a drive pinion (44) integral with the bottom bracket shell and a driven pinion (45) integral with the case (3) of the pedal so that the rotational movement of the crank (41) rotates the pedal plate (2) about the pedal pin (4).

36. Pedal set forth in claim 35, characterised in that the driven pinion (45) is integral with the case (3) of the pedal by elastic means (46).

37. Pedal set forth in claim 36, characterised in that the driven pinion (45) is integral with the case (3) of the pedal by means of a coil spring (46) located on the inside of a circular recess (47) made in the driven pinion (45) so that the axis of the spring is coaxial to the axis of rotation of the driven pinion (45), the ends of the coil spring (46) being respectively integral with the driven pinion (45) and the case (3) of the pedal.

38. Pedal set forth in claim 37, characterised in that it comprises a safety gear case (48) designed to be fitted onto the crank (41) to cover the belt (43) and the drive (44) and driven (45) pinions.
